(19) United States
(12) Patent Application Publication
(10) Pub. No.: US 2008/0220287 A1
(43) Pub. Date: Sep. 11, 2008

(54) White Organic Illuminating Diodes (Oleds) Based on Exciplex Double Blue Fluorescent Compounds

(75) Inventors: Florian Dotz, Heidelberg (DE); Wolfgang Kowalsky, Braunschweig (DE); Hans-Hermann Johannes, Braunschweig (DE); Christian Schildknecht, Braunschweig (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, LUDWIGSHAFEN (DE)

(21) Appl. No.: 12/064,768

(22) PCT Filed: Aug. 17, 2006
(86) PCT No.: PCT/EP2006/065428

§ 371 Date: Feb. 25, 2008

(30) Foreign Application Priority Data
Aug. 25, 2005 (DE) 10 2005 040 285.2

(51) Int. Cl. B32B 9/00

(52) U.S. Cl. 428/690

(57) ABSTRACT

The invention relates to an organic white light-emitting diode comprising at least one blue light-emitting fluoranthene derivative of the general formula I as component A

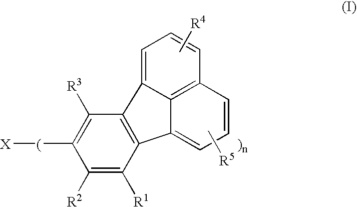

and at least one blue light-emitting arylamine derivative as component B, the HOMO energies and LUMO energies of components A and B being different, with the condition that the LUMO energy of component A is higher than the HOMO energy of component B; to a composition comprising at least one blue light-emitting fluoranthene derivative of the formula I as component A and at least one blue light-emitting arylamine derivative as component B, the HOMO energies and LUMO energies of components A and B being different, with the condition that the LUMO energy of component A is higher than the HOMO energy of component B; and also to a light-emitting layer comprising a composition and to an organic white light-emitting diode comprising an inventive composition or an inventive light-emitting layer. The invention further relates to a device selected from the group consisting of stationary visual display units such as visual display units of computers, televisions, visual display units in printers, kitchen appliances and advertising panels, illuminations, information panels and mobile visual display units such as visual display units in mobile telephones, laptops, vehicles and destination displays in buses and trains, comprising at least one inventive organic light-emitting diode, and to the use of an inventive composition in an organic white light-emitting diode.

The present invention relates to a light-emitting organic light diode comprising at least one blue light-emitting fluoranthene derivative and at least one blue light-emitting arylamine derivative, to a composition comprising at least one blue light-emitting fluoranthene derivative and at least one blue light-emitting arylamine derivative, to a light-emitting layer comprising the inventive composition, to a white light-emitting diode comprising the inventive composition, to a device comprising an inventive white light-emitting diode and to the use of the inventive composition in an organic white light-emitting diode.

Organic light-emitting diodes (OLEDs) utilize the property of materials of emitting light when they are excited by electrical current. OLEDs are of interest, for example, as an alternative to cathode ray tubes and liquid-crystal displays for the production of flat visual display units.

Numerous materials which emit light on excitation by electrical current have been proposed.

A review of light-emitting polymers is disclosed, for example, in M. T. Bernius et al., Adv. Mat. 2000, 12, 1737 to 1750. The demands on the compounds used are high and it is usually impossible to fulfill all demands made with the known materials.

White light-emitting OLEDs are of great interest especially as an illumination source or as a backlight in full-color displays. In the latter case, red, green and blue pixels are obtained by means of a color filter, as, for example, in the case of liquid-crystal technology.

In the prior art, a plurality of variants for the generation of white light in OLEDs are discussed. The basis for the emission of white light is always the superimposition of a plurality of colors, for example red, green and blue.

The individual color components needed for the emission of white light can be formulated, for example, in one layer. J. Kido et al. Appl. Phys. Lett. 67 (16), 1995, p. 2281 to 2283 relates to white light-emitting OLEDs in which the color components required are formulated in one layer. The light-emitting layer is a poly(N-vinylcarbazole)polymer (PVK) in which electron-transporting additives are molecularly dispersed. Suitable electron-transporting additives are 2-(4-biphenyl)-5-(4-tert-butylphenyl(1,3,4-oxadiazole)). In addition, the PVK layer comprises various fluorescent dyes which have different emission colors and constitute light-emitting sites. The adjustment of the concentrations of the fluorescent dyes provides an OLED which emits white light.

It is likewise known to formulate the individual color components in a plurality of mutually separate layers. C.-H. Tim et al. Appl. Phys. Lett. 2002, 80, 2201 to 2203 relates to multilayer white light-emitting OLEDs based on a CBP (4,4′-bis(9-carbazolyl)-biphenyl) layer which has been doped with a blue-green-emitting perylene, and an Alq₃ layer (tris(8-hydroxyquinoline)) which has been doped with red-emitting DCM1 (4-(dicyanomethylene)-2-methyl-6-(p-dimethylaminostyryl)-4H-pyran)).

Common to both approaches is the problem of energy transfer from the layer emitting at high energy (typically in the blue region of visible light) to the layer emitting at low energy (typically in the red region of visible light) and the associated energy loss, which is caused by balanced overlapping of the individual color components.

While both J. Kido et al. and C.-H. Tim et al. relate to the use of low molecular weight light-emitting compounds, the prior art also describes the use of polymeric electroluminescent materials in OLEDs. These polymeric materials have the advantage that they, unlike low molecular weight electroluminescent materials, can be applied from solution, for example by spin-coating or dipping, which enables large-surface area displays to be produced in a simple and inexpensive manner.

Tasch et al. Appl. Phys. Lett. 71, (20), 1997, 2883 to 2885 disclose white light-emitting OLEDs which are based on light-emitting polymers. The white light emission is achieved by using, as the emitter material, a mixture of two polymers, a blue light-emitting polymer of a conductor type (polyparaphenylene) (M-LPP) and a red-orange light-emitting polymer (poly(perylene-co-diethynylbenzene) (PPDP). When PPDP is used in an amount of 0.05% in the polymer mixture, white light emission can be achieved.

A further approach to the generation of white emission in organic light-emitting diodes is disclosed in M. Mazzeo et al., Synthetic Metals 139 (2003) 675 to 677. According to M. Mazzeo et al., white light emission can be achieved starting from binary organic mixtures by intermolecular conversion processes, the exciplex and the Forster transfer mechanisms. To generate white light by means of the exciplex mechanism, M. Mazzeo et al. use a binary mixture of a blue light-emitting diamine derivative (N,N′-diphenyl-N,N′-bis-3-methylphenyl)-1,1′-diphenyl-4,4′-diamine (TPD) and of an oligothiophene S,S-dioxide derivative having a high electron affinity and a high ionization potential 2,5-bis(trimethylcylyl)thiophene 1,1-dioxide (STO)).

In view of the prior art, it is an object of the present application to provide further white light-emitting OLEDs and also compositions which are suitable for emitting white light in OLEDs. The suitable compositions should have a high lifetime and be highly efficient and have a high quantum yield in OLEDs.

This object is achieved by an organic white light-emitting diode comprising at least one blue light-emitting fluoranthene derivative of the general formula I as component A

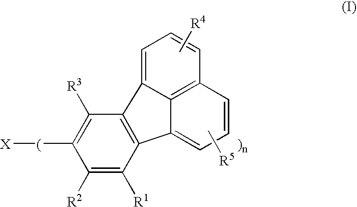

in which the symbols are each defined as follows:
R¹, R², R³, R⁴, R⁵ are each hydrogen, alkyl, an aromatic radical, a fused aromatic ring system, a heteroaromatic radical or —CH═CH₂, (E)- or (Z)-CH═CH—C₆H₅, acryloyl, methacryloyl, methylstyryl, —O—CH═CH₂ or glycidyl;
   where at least two of the R¹, R² and/or R³ radicals are not hydrogen;
X is alkyl, an aromatic radical, a fused aromatic ring system, a heteroaromatic radical or a radical of the formula (I′)

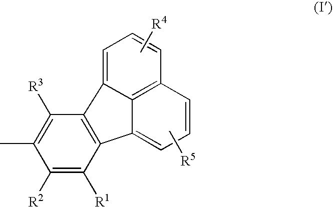

or an oligophenyl group;
n is from 1 to 10; in the case of X=oligophenyl group, 1-20;
   and at least one arylamine derivative which emits blue light as component B, the HOMO energies and LUMO energies of components A and B being different, with the condition that the LUMO energy of component A is higher than the HOMO energy of component B.

In general, the difference in the HOMO energies of components A and B is from 0.5 to 2 eV and the difference in the LUMO energies of components A and B is from 0.5 to 2 eV.

A HOMO is understood to mean the highest occupied molecular orbital and LUMO to mean the lowest unoccupied molecular orbital.

A blue light-emitting fluoranthene derivative is understood to mean a fluoranthene derivative of the formula I which generally emits light in the region of the visible electromagnetic spectrum with maxima from 430 to 480 nm, preferably from 440 to 470 nm, more preferably from 450 to 470 nm, after excitation by electrical current.

A blue light-emitting arylamine derivative is understood to mean an arylamine derivative which generally emits light in the region of the visible electromagnetic spectrum with maxima from 450 to 600 nm, preferably from 470 to 580 nm, more preferably from 490 to 560 nm.

The organic white light-emitting diode (OLED) has an electroluminescence color which generally has the following CIE coordinates (according to the standard of the Commission International de l'Eclairage): x=0.28-0.38; preferably 0.31-0.35; y=0.30-0.45; preferably 0.37-0.40.

Without being bound to a theory, it is assumed that the emission of white light of the inventive light-emitting organic light-emitting diode is formed by virtue of the overlapping of the emission of the actual blue emitter (at least one blue light-emitting fluoranthene derivative of the general formula I) with a so-called exciplex emission from the two species, component A and component B. This exciplex emission is low-energy in comparison to the blue emission and arises by virtue of interaction of the LUMO of the blue emitter with the HOMO of the arylamine derivative.

When the differences in the HOMO and LUMO energies of the two materials which are in direct contact are great enough, there is an accumulation of the electrons in the lower-energy LUMO and of the holes in the higher-energy HOMO of the two compounds. The differences mentioned between the HOMO energies of components A and B are, in accordance with the invention, generally from 0.5 to 2 eV, preferably from 0.7 to 1.7 eV, more preferably from 0.9 to 1.5 eV. The differences in the LUMO energies of components A and B are, in accordance with the invention, generally from 0.5 to 2 eV, preferably from 0.7 to 1.7 eV, more preferably from 0.9 to 1.5 eV. This gives rise to excitons of lower energy than in the actual blue emitter (component A), as a result of which lower-energy light is emitted. As a result of the superimposition of the lower-energy light with the blue emission of the blue light-emitting fluoranthene derivative of the formula I (component A), white light is emitted.

A great advantage of the inventive OLED is that both active components, specifically the at least one fluoranthene derivative of the formula I (component A) and the at least one blue light-emitting arylamine (component B) are energetically very similar and there is therefore no undesired energy transfer from a high-energy emitting compound to a low-energy emitting compound. Such an energy transfer leads to shifting of the white color coordinates and is therefore undesired.

Suitable blue light-emitting fluoranthene derivatives of the general formula I are disclosed in WO 2005/033051. The fluoranthene derivatives of the formula I disclosed in WO 2005/033051 are notable especially in that the substituents present on the fluoranthene skeleton are bonded to the fluoranthene skeleton via a C-C single bond.

The general terms “alkyl”, “aromatic radical”, “fused aromatic ring system”, “heteroaromatic radical”, “oligophenyl group” used in the present application are defined further hereinbelow:

In the context of the present application, “alkyl” means a linear, branched or cyclic, substituted or unsubstituted C₁- to C₂₀-alkyl group, preferably C₁- to C₉-alkyl group. If X and R² are an alkyl group, they are preferably a linear or branched C₃- to C₁₀-alkyl group, more preferably C₅- to C₉-alkyl group. The alkyl groups may be unsubstituted or substituted by aromatic radicals, halogen, nitro, ether or carboxyl groups. The alkyl groups are more preferably unsubstituted or substituted by aromatic radicals. Preferred aromatic radicals are specified below. In addition, one or more nonadjacent carbon atoms of the alkyl group which is/are not bonded directly to the fluoranthene skeleton may be replaced by Si, P, O or S, preferably by O or S.

In the context of the present application, “aromatic radical” preferably means a C₆-aryl group (phenyl group). This aryl group may be unsubstituted or substituted by linear, branched or cyclic C₁- to C₂₀-alkyl groups, preferably C₁- to C₉-alkyl groups, which may in turn be substituted by halogen, nitro, ether or carboxyl groups or are substituted by one or more groups of the formula I′. In addition, one or more carbon atoms of the alkyl group may be replaced by Si, P, O, S or N, preferably O or S. In addition, the aryl groups or the heteroaryl groups may be substituted by halogen, nitro, carboxyl groups, amino groups or alkoxy groups or C₆- to C₁₄-aryl groups, preferably C₆- to C₁₀-aryl groups, especially phenyl or naphthyl groups. More preferably, “aromatic radical” means a C₆-aryl group which is optionally substituted by one or more groups of the formula I′, by halogen, preferably Br, Cl or F, amino groups, preferably NAr′Ar″ where Ar′ and Ar″ are each independently C₆-aryl groups which, as defined above, may be unsubstituted or substituted, and the aryl groups Ar′ and Ar″, in addition to the aforementioned groups, may also each be substituted by at least one radical of the formula I′; and/or nitro groups. Most preferably, this aryl group is unsubstituted or substituted by NAr′Ar″.

In the context of the present application, “fused aromatic ring system” means a fused aromatic ring system having generally from 10 to 20 carbon atoms, preferably from 10 to 14 carbon atoms. These fused aromatic ring systems may be unsubstituted or substituted by linear, branched or cyclic C₁- to C₂₀-alkyl groups, preferably C₁- to C₉-alkyl groups, which may in turn be substituted by halogen, nitro, ether or carboxyl groups. In addition, one or more carbon atoms of the alkyl group may be replaced by Si, P, O, S or N, preferably O or S. In addition, the fused aromatic groups may be substituted by halogen, nitro, carboxyl groups, amino groups or alkoxy groups or C₆- to C₁₄-aryl groups, preferably C₆- to C₁₀-aryl groups, in particular phenyl or naphthyl groups. More preferably, “fused aromatic ring system” means a fused aromatic ring system which is optionally substituted by halogen, preferably Br, Cl or F, amino groups, preferably NAr′Ar″ where Ar′ and Ar″ are each independently C₆-aryl groups which, as defined above, may be unsubstituted or substituted, and the aryl groups Ar′ and Ar″, in addition to the aforementioned groups, may also each be substituted by at least one radical of the formula I′, or nitro groups. Most preferably, the fused aromatic ring system is unsubstituted. Suitable fused aromatic ring systems are, for example, naphthalene, anthracene, pyrene, phenanthrene or perylene.

In the context of the present application, “heteroaromatic radical” means a C₄- to C₁₄-heteroaryl group, preferably C₄- to C₁₀-heteroaryl group, more preferably C₄- to C₅-heteroaryl group, comprising at least one nitrogen or sulfur atom. This heteroaryl group may be unsubstituted or substituted by linear, branched or cyclic C₁- to C₂₀-alkyl groups, preferably C₁- to C₉-alkyl groups, which may in turn be substituted by halogen, nitro, ether or carboxyl groups. In addition, one or more carbon atoms of the alkyl group may be replaced by Si, P, O, S or N, preferably O or S. In addition, the heteroaryl groups may be substituted by halogen, nitro, carboxyl groups, amino groups or alkoxy groups or C₆- to C₁₄-aryl groups, preferably C₆- to C₁₀-aryl groups. More preferably, “heteroaromatic radical” means a heteroaryl group which is optionally substituted by halogen, preferably Br, Cl or F, amino groups, preferably NArAr′, where Ar and Ar′ are each independently C₆-aryl groups which, as defined above, may be unsubstituted or substituted, or nitro groups. Most preferably, the heteroaryl group is unsubstituted.

In the context of the present application, “oligophenyl group” means a group of the general formula (IV)

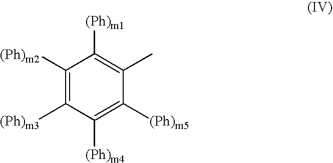

where Ph is in each case phenyl which may be substituted in all 5 substitutable positions in each case in turn with a group of the formula (IV);
m¹, m², m³, m⁴ and m⁵ are each independently 0 or 1, where at least one index m¹, m², m³, m⁴ or m⁵ is 1.

Preference is given to oligophenyls in which m¹, m³ and m⁵ are each 0 and m² and m⁴ are each 1, or to oligophenyls in which m¹, m², m⁴ and m⁵ are each 0 and m³ is 1, and also to oligophenyls in which m² and m⁴ are each 0 and m¹, m⁵ and m³ are each 1.

The oligophenyl group may thus be a dendritic, i.e. hyperbranched, group, especially when m¹, m³ and m⁵ are each 0 and m² and m⁴ are each 1, or when m² and m⁴ are each 0 and m¹, m³ and m⁵ are each 1, and the phenyl groups are in turn substituted in from 1 to 5 of their substitutable positions by a group of the formula (IV), preferably in 2 or 3 positions, more preferably, in the case of substitution in 2 positions, in each case in the meta-position to the bonding site with the basic structure of the formula (IV) and, in the case of substitution in 3 positions, in each case in the ortho-position and in the para-position to the bonding site with the basic structure of the formula (IV).

However, the oligophenyl group may also be substantially unbranched, especially when only one of the indices m¹, m², m³, m⁴ or m⁵ is 1, it being preferred in the unbranched case that m³ is 1 and m¹, m², m⁴ and m⁵ are each 0. The phenyl group may in turn be substituted in from 1 to 5 of its substitutable positions by a group of the formula (IV); the phenyl group is preferably substituted at one of its substitutable positions by a group of the formula (IV), more preferably in the para-position to the bonding site with the basic structure. In the following, the substituents bonded directly to the basic structure are known as first substituent generations. The group of the formula (IV) may in turn be substituted as defined above. In the following, the substituents bonded to the first substituent generation are known as second substituent generation.

In accordance with the first and second substituent generations, any number of further substituent generations are possible. Preference is given to oligophenyl groups with the aforementioned substitution patterns which have a first and a second substituent generation or oligophenyl groups which only have a first substituent generation.

In the context of the present application, an “oligophenyl group” is also understood to mean those groups which are based on a basic structure of one of the formulae V, VI or VII:

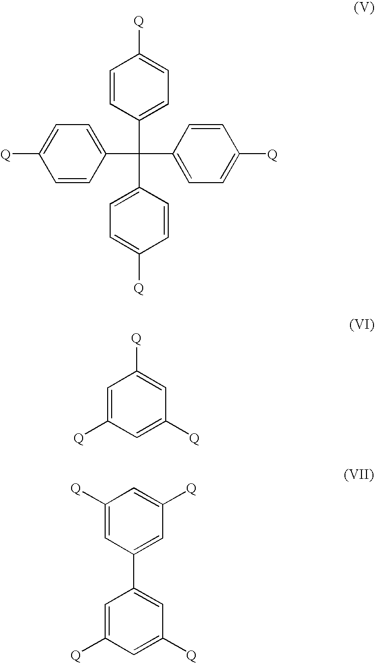

where Q is in each case a bond to a radical of the formula I′ or a group of the formula VIII:

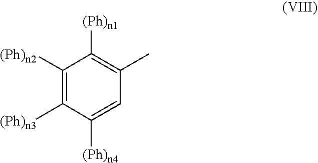

where Ph in each case is phenyl which may be substituted in turn by a group of the formula VIII in not more than 4 positions in accordance with the substitution pattern of the central phenyl ring of the group of the formula VIII;
n¹, n², n³ and n⁴ are each independently 0 or 1, it being preferred that n¹, n², n³ and n⁴ are each 1.

The oligophenyl groups of the formulae V, VI and VII may thus be dendritic, i.e. hyperbranched groups.

The oligophenyls of the formulae IV, V, VI and VII are substituted by from 1 to 20, preferably from 4 to 16, more preferably from 4 to 8 radicals of the formula (I′), where one phenyl radical may be substituted by no, one or more radicals of the formula (I′). A phenyl radical is preferably substituted by one or no radical of the formula (I′), at least one phenyl radical being substituted by a radical of the formula (I′).

Very particularly preferred compounds of the formula I in which X is an oligophenyl radical of the general formula IV are specified below:

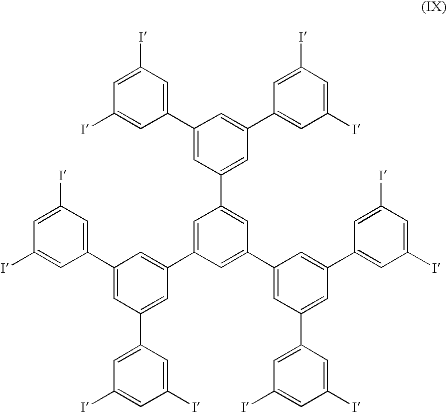

Very particularly preferred compounds of the formula I in which X is an oligophenyl radical of the general formulae V, VI or VII are specified below:

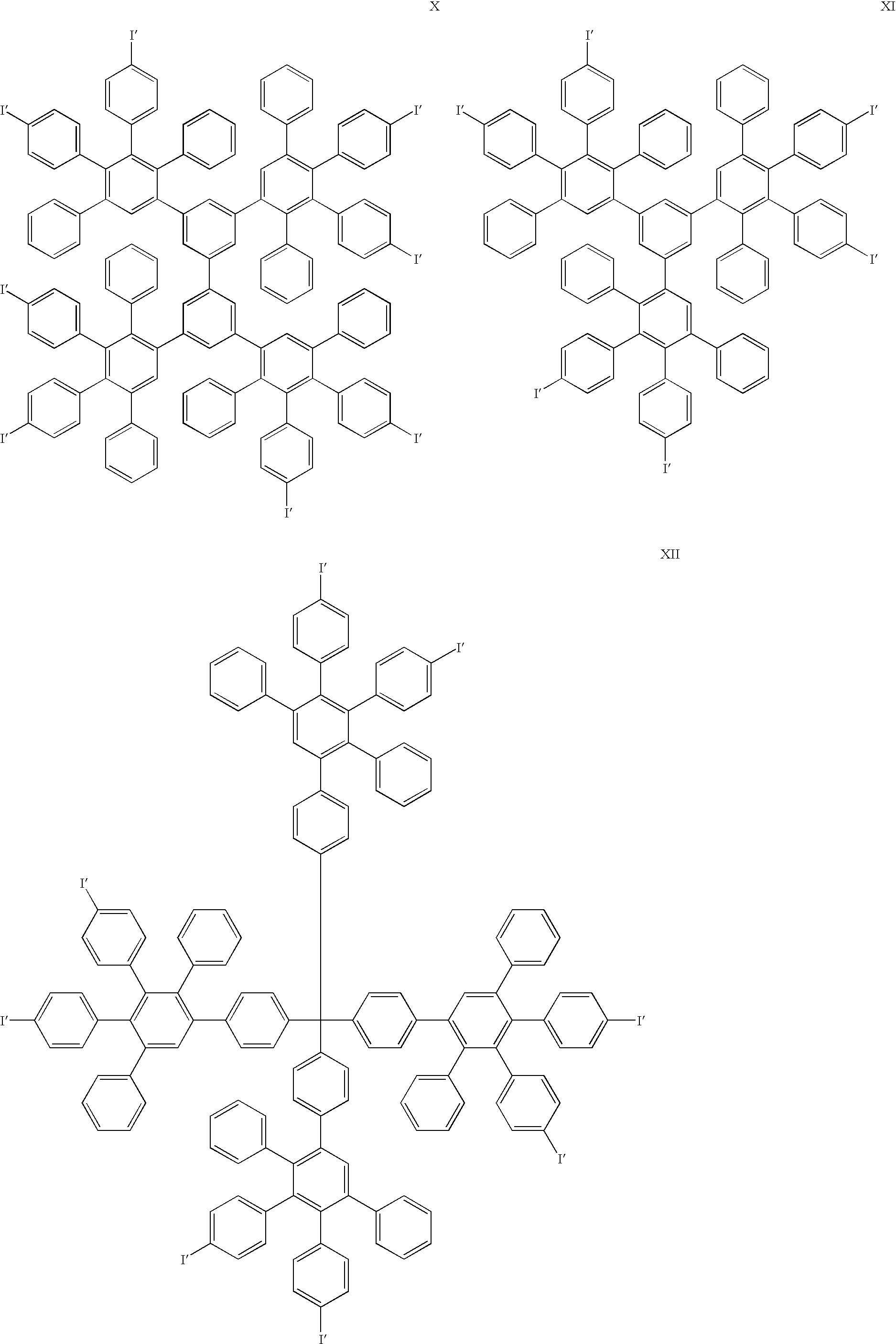

The R¹, R², R³, R⁴, R⁵ and X radicals may each independently be selected from the aforementioned radicals.

R⁴ and R⁵ are preferably each hydrogen.

R¹ and R³ are preferably each an aromatic radical, a fused aromatic ring system or a radical of the formula I′, more preferably an aromatic radical, preferred embodiments of the aromatic radical already having been listed above. Most preferably, R¹ and R³ are each phenyl.

R² is preferably hydrogen, alkyl, preferred embodiments of the alkyl radical already having been listed above, more preferably C₁- to C₉-alkyl, which is most preferably unsubstituted and linear, an aromatic radical, preferred aromatic radicals already having been mentioned above, more preferably a phenyl radical.

X is preferably an aromatic radical, preferred aromatic radicals already having been mentioned above, more preferably a C₆-aryl radical which, depending on n, is mono- to trisubstituted by fluoranthenyl radicals, or a fused aromatic ring system, preferred fused aromatic ring systems already having been mentioned above, more preferably a C₁₀ to C₁₄ fused aromatic ring system, most preferably naphthyl or anthracenyl, the fused aromatic ring system being mono- to trisubstituted by fluoranthenyl radicals depending on n. When X is an aromatic radical having 6 carbon atoms, this radical is preferably substituted by fluoranthenyl radicals in the 1- and 4-position or the 1-, 3- and 5-position. When X is, for example, an anthracenyl radical, it is preferably substituted in the 9- and 10-position by fluoranthenyl radicals. In this context, fluoranthenyl radicals are understood to mean moieties of the formula I′ shown below

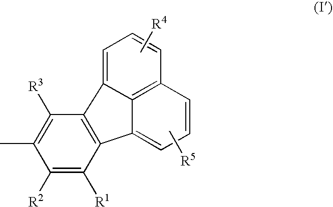

It is also possible that the X radical itself is a fluoranthenyl radical of the formula I′.

In addition, X may be an oligophenyl group, preferred oligophenyl groups already having been mentioned above. Preference is given to an oligophenyl group of the general formula (IV) in which m¹, m², m³, m⁴ and m⁵ are each 0 or 1, at least one of the indices m¹, m², m³, m⁴ or m⁵ being 1.

n is an integer from 1 to 10, preferably from 1 to 4, more preferably from 1 to 3, most preferably 2 or 3. This means that the fluoranthene derivatives of the general formula I preferably have more than one fluoranthenyl radical of the general formula I′. Preference is thus likewise given to those compounds in which X itself is a fluoranthenyl radical. When X is an oligophenyl group, n is an integer from 1 to 20, preferably from 4 to 16.

Very particular preference is given to fluoranthene derivatives of the general formula I which do not have any heteroatoms.

In a very particularly preferred embodiment, X is an optionally substituted phenyl radical and n is 2 or 3. This means that the phenyl radical is substituted by 2 or 3 radicals of the formula I′. The phenyl radical preferably does not comprise any further substituents. When n is 2, the radicals of the formula I′ are each in the para-position to one another. When n is 3, the radicals are each in the meta-position to one another.

In a further preferred embodiment, X is an optionally substituted phenyl radical and n is 1, i.e. the phenyl radical is substituted by one radical of the formula I′.

Preference is also given to X being an anthracenyl radical and to n being 2. This means that the anthracenyl radical is substituted by 2 radicals of the formula I′. These radicals are preferably in the 9- and 10-position of the anthracenyl radical.

The preparation of the inventive fluoranthene derivatives of the general formula I can be carried out by all suitable processes known to those skilled in the art. In a preferred embodiment, the fluoranthene derivatives of the formula I are prepared by reacting cyclopentaacenaphthenone derivatives (referred to hereinbelow as acecyclone derivatives). Suitable preparation processes for compounds of the formula I in which n is 1 are disclosed, for example, in Dilthey et al., Chem. Ber. 1938, 71, 974 and Van Allen et al., J. Am. Chem. Soc., 1940, 62, 656.

Preferred processes for preparing the fluoranthene derivatives of the general formula I are specified in WO 2005/033051.

The fluoranthene derivatives of the general formula I feature an absorption maximum in the ultraviolet region of the electromagnetic spectrum and an emission maximum in the blue region of the electromagnetic spectrum. The quantum yield of the fluoranthene derivatives of the general formula I is generally from 20 to 75% in toluene. Fluoranthene derivatives of the general formula I in which n is 2 or 3 generally have particularly high quantum yields of over 50%.

Very particularly preferred fluoranthene derivatives of the formula I which are used in the inventive white light-emitting OLEDs are selected from the group consisting of 7,8,9,10-tetraphenylfluoranthene, 8-naphthyl-2-yl-7,10-diphenylfluoranthene, 8-nonyl-9-octyl-7,10-diphenylfluoranthene, benzene-1,4-bis-(2,9-diphenylfluoranth-1-yl), benzene-1,3,5-tris(2,9-diphenylfluoranth-1-yl), 9,9′-dimethyl-7,10,7′,10′-tetraphenyl-[8,8′]-difluoranthene, 9,10-bis(2,9,10-triphenylfluoranthen-1-yl)anthracene and 9,10-bis(9,10-diphenyl-2-octylfluoranthen-1-yl)anthracene.

The blue light-emitting arylamine derivative is generally a hole conductor based on arylamine, as are typically used in OLEDs and are known to those skilled in the art. Suitable hole conductors based on arylamine are disclosed, for example, in Kirk-Othmer Encyclopedia of Chemical Technology, 4th edition, Vol. 18, pages 837 to 860, 1996.

Preferred arylamine derivatives are tertiary aromatic amines selected from the group consisting of triphenylamines of the benzidine type, triphenylamines of the styrylamine type, triphenylamines of the diamine type.

Especially suitable arylamine derivatives are selected from the group consisting of 4,4′,4″-tris(N-(1-naphthyl)-N-phenylamino)triphenylamine (1-TNATA), or 4,4′,4″-tris-(N-(2-naphthyl)-N-phenylamino)triphenylamine (2-TNATA), 4,4′-bis[N-(1-naphthyl)-N-phenyl-amino]biphenyl (α-NPD), N,N′-diphenyl-N,N′-bis(3-methylphenyl)-[1,1′-biphenyl]-4,4′-diamine (TPD), 1,1-bis[(di-4-tolylamino)phenyl]cyclohexane (TAPC), N,N′-bis(4-methylphenyl)-N,N′-bis(4-ethylphenyl)-[1,1′-(3,3′-dimethyl)biphenyl]-4,4′-diamine (ETPD), tetrakis(3-methylphenyl)-N,N,N′,N′-2,5-phenylenediamine (PDA), α-phenyl-4-N,N-diphenylaminostyrene (TPS), p-(diethylamino)benzaldehyde diphenylhydrazone (DEH), triphenylamine (TPA), bis[4-(N,N-diethylamino)-2-methylphenyl)(4-methylphenyl)methane (MPMP), 1-phenyl-3-[p-(diethylamino)styryl]-5-[p-(diethylamino)phenyl]pyrazoline (PPR or DEASP) and N,N,N′,N′-tetrakis(4-methylphenyl)-(1,1′-biphenyl)-4,4′-diamine (TTB).

Preferred arylamine derivatives are selected from 1-TNATA, 2-TNATA, A-NPD, TPD, TAPC, ETPD, PDA, TPS, TPA, MPMP and TTB. Very particular preference is given to the arylamine derivatives selected from 1-TNATA, 2 TNATA, A-NPD, TPD, TAPC, TPA and TTB.

The arylamine derivative used in the present invention is most preferably 4,4′,4″-tris(N-(1-naphthyl)-N-phenylamino)triphenylamine (1-TNATA) or 4,4′,4″-tris-(N-2-naphthyl)-N-phenylamino)triphenylamine (2-TNATA).

In the inventive white light-emitting OLED, the at least one blue light-emitting fluoranthene derivative of the general formula I (component A) and the at least one blue light-emitting arylamine derivative (component B) are present in the form of a mixture in one layer of an OLED or in two adjacent layers of an OLED. The at least one component A and the at least one component B are preferably present in two immediately adjacent layers.

The present application therefore further provides a composition comprising at least one blue light-emitting fluoranthene derivative of the formula I as component A and at least one blue light-emitting arylamine as component B, the HOMO energies and LUMO energies of components A and B being different with the condition that the LUMO energy of component A is higher than the HOMO energy of component B.

In general, the difference in the HOMO energies of components A and B is from 0.5 to 2 eV and the difference in the LUMO energies of components A and B is from 0.5 to 2 eV. Preferred embodiments of components A and B and the differences in their HOMO and LUMO energies have already been specified above.

The present application further provides a light-emitting layer comprising the aforementioned inventive composition, and also an organic white light-emitting diode (OLED) comprising the inventive composition or the inventive light-emitting layer, each of which has been described above.

The present application further relates to the use of the inventive composition which has already been described above in an organic white light-emitting diode.

Organic light-emitting diodes (OLEDS) are in principle formed from a plurality of layers, for example:

### 1. Anode

2. Hole-transporting layer
3. Light-emitting layer
4. Electron-transporting layer

### 5. Cathode

However, it is also possible that the OLED does not have all of the layers mentioned; for example an OLED having the layers (1) (anode), (3) (light-emitting layer) and (5) (cathode) is likewise suitable, in which case the functions of the layers (2) (hole-transporting layer) and (4) (electron-transporting layer) are assumed by the adjacent layers. OLEDs which have the layers (1), (2), (3) and (5) or the layers (1), (3), (4) and (5) are likewise suitable.

The individual aforementioned layers of the OLED may in turn be composed of two or more layers. For example, the hole-transporting layer may be composed of one layer into which holes are injected from the electrode and one layer which transports the holes from the hole-injecting layer away into the light-emitting layer. The electron-transporting layer may likewise consist of a plurality of layers, for example one layer in which electrons are injected by the electrode and one layer which receives electrons from the electron-injecting layer and transports them into the light-emitting layer. These layers are each selected according to factors such as energy level, thermal resistance and charge carrier mobility, and also energy difference of the layers mentioned with the organic layers or the metal electrodes. Those skilled in the art are capable of selecting the structure of the OLED in such a way that it is adapted optimally to the fluoranthene derivatives and arylamine derivatives used as emitter substances in accordance with the invention.

In order to obtain particularly efficient OLEDs, the HOMO (highest occupied molecular orbital) of the hole-transporting layer should be aligned to the work function of the anode, and the LUMO (lowest unoccupied molecular orbital) of the electron-transporting layer should be aligned to the work function of the cathode.

The anode (1) is an electrode which provides positive charge carriers. It may be composed, for example, of materials which comprise a metal, a mixture of different metals, a metal alloy, a metal oxide or a mixture of different metal oxides. Alternatively, the anode may be a conductive polymer. Suitable metals include the metals of groups IA, IVB, VB and VIB of the Periodic Table of the Elements, and also the transition metals of group VIII. When the anode is to be transparent, mixed metal oxides of groups IIB, IIIA and IVA of the Periodic Table of the Elements (CAS version) are generally used, for example indium tin oxide (ITO). It is likewise possible that the anode (1) comprises an organic material, for example polyaniline, as described, for example, in Nature, Vol. 357, pages 477 to 479 (Jun. 11, 1992). At least either the anode or the cathode should be at least partly transparent in order to be able to emit the light formed.

The hole transport material used for the layer (2) of the inventive OLED is at least one arylamine derivative as described above. In addition, the inventive OLED may comprise further hole transport materials, as disclosed, for example, in Kirk-Othmer Encyclopedia of Chemical Technology, 4th edition, Vol. 18, pages 837 to 860, 1996, provided that these hole transport materials are arranged between component B and the anode and not between component A and component B. Both hole-transporting molecules and polymers may be used as a hole transport material.

Hole-transporting molecules typically used in addition to the at least one arylamine derivative are selected from the group consisting of 1,2-trans-bis(9H-carbazol-9-yl)-cyclobutane (DCZB) and porphyrin compounds, and also phthalocyanines such as copper phthalocyanines. Hole-transporting polymers typically used in addition are selected from the group consisting of polyvinylcarbazoles and derivatives thereof, polysilanes and derivatives thereof, for example (phenylmethyl)polysilanes and polyanilines, polysiloxanes and derivatives which have an aromatic amino group in the main or side chain, polythiophene and derivatives thereof, preferably PEDOT (poly(3,4-ethylenedioxythiophene)), more preferably PEDOT doped with PSS (polystyrene sulfonate), polypyrrole and derivatives thereof, poly(p-phenylenevinylene) and derivatives thereof. Examples of suitable hole transport materials are specified, for example, in JP-A 63070257, JP-A 63175860, JP-A 2 135 359, JP-A 2 135 361, JP-A 2 209 988, JP-A 3 037 992 und JP-A 3 152 184. It is likewise possible to obtain hole-transporting polymers by doping hole-transporting molecules into polymers such as polystyrene, polyacrylate, poly(methacrylate), poly(methyl methacrylate), poly(vinyl chloride), polysiloxanes and polycarbonate. To this end, the hole-transporting molecules are dispersed in the polymers mentioned which serve as polymeric binders. Suitable hole-transporting molecules are the molecules already mentioned above. Preferred hole transport materials are the hole-transporting polymers mentioned; the preparation of the compounds mentioned as hole transport materials is known to those skilled in the art.

Instead of a hole-transporting layer (2), the blue light-emitting arylamine derivative used as a hole transport material in accordance with the invention may, in a further embodiment, be used in the light-emitting layer (3) as a mixture together with the fluoranthene derivative of the formula I used in accordance with the invention.

The light-emitting layer (3) may comprise the fluoranthene derivative of the general formula I alone or as a mixture with the blue light-emitting arylamine derivative. However, it is likewise possible that further compounds are present in the light-emitting layer in addition to the fluoranthene derivative of the formula I and, if appropriate, the blue light-emitting arylamine derivative. For example, a diluent material may be used. This diluent material may be a polymer, for example poly(N-vinylcarbazole) or polysilane. The diluent material may, however, likewise be a small molecule, for example 4, 4′-N,N′-dicarbazolebiphenyl (CDP) or tertiary aromatic amines. When a diluent material is used, the content of fluoranthene derivatives of the formula I in the light-emitting layer is generally less than 20% by weight, preferably from 3 to 10% by weight. The light-emitting layer preferably does not comprise any further compounds in addition to the at least one fluoranthene derivative of the formula I and, if appropriate, the at least one blue light-emitting arylamine derivative.

Suitable electron-transporting materials for layer (4) of the inventive OLEDs comprise metals chelated with oxinoid compounds, such as tris(8-quinolinolato)aluminum (Alq₃), compounds based on phenanthroline, such as 2,9-dimethyl-4,7-diphenyl-1,10-phenanthroline (DDPA=BCP) or 4,7-diphenyl-1,10-phenanthroline (DPA) and azole compounds such as 2-(4-biphenylyl)-5-(4-t-butylphenyl)-1,3,4-oxadiazole (PBD) and 3-(4-biphenylyl)-4-phenyl-5-(4-t-butylphenyl)-1,2,4-triazole (TAZ), anthraquinone-dimethane and derivatives thereof, benzoquinone and derivatives thereof, naphthoquinone and derivatives thereof, fluorenone derivatives, diphenyldicyanoethylene and derivatives thereof, diphenoquinone derivatives, polyquinoline and derivatives thereof, polyquinoxaline and derivatives thereof and polyfluorene and derivatives thereof. Examples of suitable electron-transporting materials are disclosed, for example, in JP-A 63070257, JP-A 63 175860, JP-A 2 135 359, JP-A 2 135 361, JP-A 2 209 988, JP-A 3 037 992 and JP-A 3 152 184. Preferred electron-transporting materials are azole compounds, benzoquinone and derivatives thereof, anthraquinone and derivatives thereof, polyfluorene and derivatives thereof. Particular preference is given to 2-(4-biphenyl)-5-(4-t-butylphenyl)-1,3,4-oxadiazole, benzoquinone, anthraquinone, Alq₃, BCP and polyquinoline. The nonpolymeric electron-transporting materials may be mixed with a polymer as a polymeric binder. Suitable polymeric binders are polymers which do not have a strong absorption of light in the visible region of the electromagnetic spectrum. Suitable polymers are the polymers which have already been mentioned as polymeric binders with regard to the hole-transporting materials. The layer (4) may serve both to ease the electron transport and as a buffer layer or as a barrier layer in order to prevent quenching of the exciton at the interfaces of the layers of the OLED. The layer (4) preferably improves the mobility of the electrons and reduces quenching of the exciton.

Of the materials specified above as hole-transporting materials and electron-transporting materials, some can fulfill a plurality of functions. For example, some of the electron-conducting materials are simultaneously hole-blocking materials when they have a low-lying HOMO.

The charge transport layers may also be electronically doped in order to improve the transport properties of the materials used, in order firstly to make the layer thicknesses more generous (avoidance of pinholes/short circuits) and secondly to minimize the operating voltage of the device. For example, the hole-transporting materials may be doped with electron acceptors; for example, phthalocyanines or arylamines such as TPD or TDTA may be doped with tetrafluorotetracyanoquinodimethane (F4-TCNQ). The electron-transporting materials may, for example, be doped with alkali metals, for example Alq₃ with lithium. Electronic doping is known to those skilled in the art and is disclosed, for example, in W. Gao, A. Kahn, J. Appl. Phys., Vol. 94, No. 1, Jul. 1, 2003 (p-doped organic layers); A. G. Werner, F. Li, K. Harada, M. Pfeiffer, T. Fritz, K. Leo, Appl. Phys. Lett., Vol. 82, No. 25, Jun. 23, 2003 and Pfeiffer et al., Organic Electronics 2003, 4, 89-103.

The cathode (5) is an electrode which serves to introduce electrons or negative charge carriers. The cathode may be any metal or nonmetal that has a lower work function than the anode. Suitable materials for the cathode are selected from the group consisting of alkali metals of group IA, for example Li, Cs, alkaline earth metals of group IIA, metals of group IIB of the Periodic Table of the Elements (CAS version), including the rare earth metals and the lanthanides and actinides. In addition, metals such as aluminum, indium, calcium, barium, samarium and magnesium, and combinations thereof, may also be used. In addition, lithium-containing organometallic compounds or LiF may be applied between the organic layer and the cathode in order to reduce the operating voltage.

The OLED of the present invention may additionally comprise further layers which are known to those skilled in the art, as long as the hole-transporting layer (2) comprising component B and the light-emitting layer (3) comprising component A are immediately adjacent. For example, additional layers may be present between the light-emitting layer (3) and the layer (4) in order to ease the transport of the negative charge and/or to match the band gaps between the layers to one another. Alternatively, this layer may serve as a protective layer.

In a preferred embodiment, the inventive OLED, in addition to layers (1) to (5), comprises at least one of the further layers mentioned below:
a hole injection layer between the anode (1) and the hole-transporting layer (2);
a blocking layer for holes and/or excitons between the light-emitting layer (3) and the electron-transporting layer (4);
an electron injection layer between the electron-transporting layer (4) and the cathode (5).

However, it is also possible that the OLED does not have all of the layers specified; for example, an OLED having the layers (1) (anode), (3) (light-emitting layer) and (5) (cathode) is likewise suitable, in which case the functions of the layers (2) (hole-transporting layer) and (4) (electron-transporting layer) are assumed by the adjacent layers. OLEDs which have the layers (1), (2), (3) and (5) or the layers (1), (3), (4) and (5) are likewise suitable.

Preference is given to an OLED comprising the layers (1), (2), (3), (4) and (5), particular preference to one comprising (1), (3), (4) and (5), the light-emitting layer (3) having at least one blue light-emitting arylamine derivative in addition to the at least one fluoranthene derivative of the formula I.

Those skilled in the art know how suitable materials have to be selected (for example on the basis of electrochemical investigations). Suitable materials for the individual layers are known to those skilled in the art and disclosed, for example, in WO 00/70655.

Furthermore, each of the specified layers of the inventive OLED may be composed of two or more layers. In addition, it is possible that some or all of the layers (1), (2), (3), (4) and (5) have been surface-treated in order to increase the efficiency of charge carrier transport. The selection of the materials for each of the layers mentioned is preferably determined by obtaining an OLED having a high efficiency.

The inventive OLED can be produced by methods known to those skilled in the art. In general, the OLED is produced by successive vapor deposition of the individual layers onto a suitable substrate when the layers are formed from evaporable molecules, i.e. molecules having a low molecular weight. Suitable substrates are preferably transparent substrates, for example glass or polymer films. For the vapor deposition, customary techniques may be used, such as thermal evaporation, chemical vapor deposition and others. In an alternative process, when the layers are formed from polymeric materials, the organic layers of the OLED may be coated from solutions or dispersions in suitable solvents, in which case coating techniques known to those skilled in the art are employed, for example spin-coating, printing or knife-coating.

The application itself may be effected by conventional techniques, for example spin-coating, dipping or by film-forming knife-coating (screenprinting technique), by application with an inkjet printer or by stamp printing, for example by PDMS (stamp printing by means of a silicone rubber stamp which has been photochemically structured).

In general, the different layers have the following thicknesses: anode (2) from 500 to 5000 Å, preferably from 1000 to 2000 Å; hole-transporting layer (3) from 50 to 1000 Å, preferably from 200 to 800 Å; light-emitting layer (4) from 10 to 2000 Å, preferably from 30 to 1500 Å; electron-transporting layer (5) from 50 to 1000 Å, preferably from 100 to 800 Å; cathode (6) from 200 to 10 000 Å, preferably from 300 to 5000 Å. The position of the recombination zone of holes and electrons in the inventive OLED and thus the emission spectrum of the OLED may be influenced by the relative thickness of each layer. This means that the thickness of the electron transport layer should preferably be selected such that the electron/hole recombination zone is within the light-emitting layer. The ratio of the layer thicknesses of the individual layers in the OLED is dependent upon the materials used. The layer thicknesses of any additional layers used if appropriate are known to those skilled in the art.

The inventive OLEDs have a high efficiency. The efficiency of the inventive OLEDs may additionally be improved by optimizing the other layers. For example, highly efficient cathodes such as Ca, Ba or LiF may be used in conjunction with metals such as Ca, Ba, Al. Shaped substrates and novel hole-transporting materials which bring about a reduction in the operating voltage or an increase in the efficiency are likewise usable in the inventive OLEDs. Furthermore, additional layers may be present in the OLEDs in order to adjust the energy level of the different layers and to ease electroluminescence.

The inventive OLEDs may be used in all devices in which electroluminescence is useful. Suitable devices are preferably selected from stationary and mobile visual display units. Stationary visual display units are, for example, visual display units of computers, televisions, visual display units in printers, kitchen appliances and advertising panels, illuminations and information panels. Mobile visual display units are, for example, visual display units in mobile telephones, laptops, vehicles and destination displays on buses and trains.

Furthermore, the inventive blue light-emitting fluoranthene derivatives (component A)/blue light-emitting arylamine derivatives (component B) may be used in OLEDs with inverse structure. The blue light-emitting fluoranthene derivatives (component A)/blue light-emitting arylamine derivatives (component B) used in accordance with the invention are preferably used in these inverse OLEDs in turn in the light-emitting layer, more preferably as the light-emitting layer without further additives. The structure of inverse OLEDs and the materials typically used therein are known to those skilled in the art.

The examples which follow provide additional illustration of the invention.

### EXAMPLE

An OLED is produced which has the following structure:

### OLED Structure

A: Al: Aluminum (cathode)
B: LiF: Lithium fluoride (electron injection layer)
C: BCP: 2,9-Dimethyl-4,7-diphenyl-1,10-phenanthroline (bathocuproin) (hole blocking layer); layer thickness: 10 nm
D: TPF: 7,8,9,10-Tetraphenylfluoranthene (blue emitter, component A); layer thickness: 50 nm
E: 1-TNATA: 4,4′,4″-Tris(N-(1-naphthyl)-N-phenylamino)triphenylamine (blue light-emitting arylamine derivative, component B); layer thickness: 50 nm
F: ITO: Indium tin oxide (transparent anode)

The OLED is produced as follows:

ITO-coated glass was cleaned with acetone and isopropanol in an ultrasound bath, followed by a UV-ozone treatment. The emitting surface was defined lithographically by applying a passivating layer of the photoresist AZ 5214 (Hoechst) by spin-coating. All further materials were applied by vapor deposition sequentially in ultra-high vacuum.

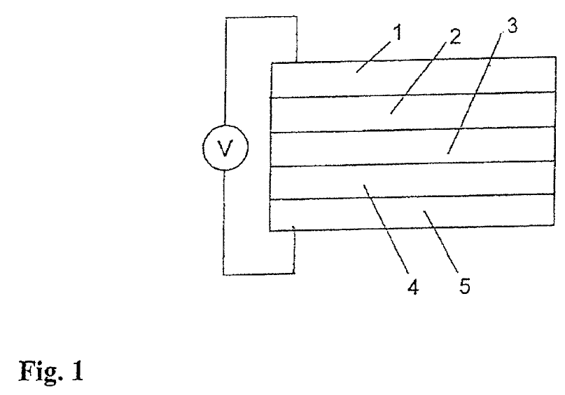

FIG. 1 shows the structure of the OLED of the present example.

In this figure:
1: LiF/AI
2: BCP
3: TPF
4: 1-TNATA
5: ITO

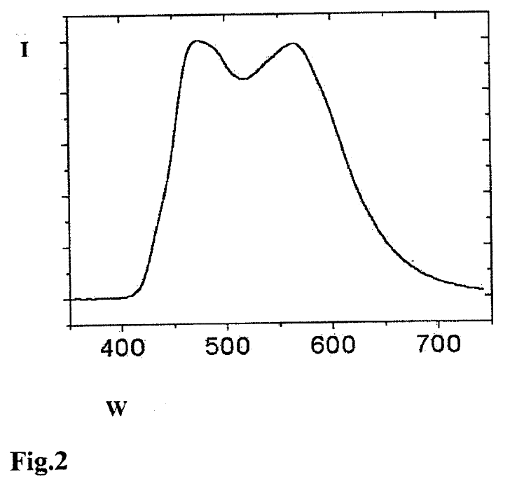

FIG. 2 shows the emission spectrum of the OLED of FIG. 1.

In this figure:
I: Intensity a.u. (arbitrary units)
W: Wavelength [nm]

It can be seen from FIG. 2 that an OLED with the inventive structure shown in FIG. 1 emits white light. The CIE coordinates (according to the standard of the Commission International de l'Eclairage) of the spectrum are: x=0.314; y=0.39.

1-15. (canceled)

16. An organic white light-emitting diode comprising at least one blue light-emitting fluoranthene derivative of the general formula I as component A 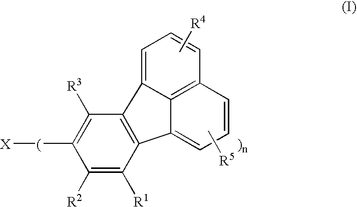
in which the symbols are each defined as follows:
R¹, R², R³, R⁴, R⁵ are each hydrogen, alkyl, an aromatic radical, a fused aromatic ring system, a heteroaromatic radical or —CH═CH₂, (E)- or (Z)-CH═CH—C₆H₅, acryloyl, methacryloyl, methylstyryl, —O—CH═CH₂ or glycidyl;
where at least two of the R¹, R² and/or R³ radicals are not hydrogen;
X is alkyl, an aromatic radical, a fused aromatic ring system, a heteroaromatic radical or a radical of the formula (I′) 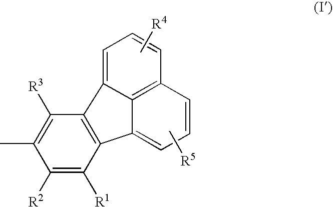
or an oligophenyl group;
n is from 1 to 10; in the case of X=oligophenyl group, 1-20;
and at least one arylamine derivative which emits blue light as component B, the HOMO energies and LUMO energies of components A and B being different, with the condition that the LUMO energy of component A is higher than the HOMO energy of component B.

17. The organic white light-emitting diode according to claim 16, wherein the difference in the HOMO energies of components A and B is from 0.5 to 2 eV and the difference in LUMO energies of components A and B is from 0.5 to 2 eV.

18. The organic white light-emitting diode according to claim 16, wherein R⁴ and R⁵ are each hydrogen in the at least one fluoranthene derivative of the formula I.

19. The organic white light-emitting diode according to claim 16, wherein R¹ and R³ are each a phenyl radical in the at least one fluoranthene derivative of the formula I.

20. The organic white light-emitting diode according to claim 16, wherein X in the at least one fluoranthene derivative of the formula I is an aromatic radical, a fused aromatic ring system or a radical of the formula I, or is an oligophenyl group.

21. The organic white light-emitting diode according to claim 20, wherein n is 2 or 3 or, when X is an oligophenyl group, from 1 to 20 in the at least one fluoranthene derivative of the formula I.

22. The organic white light-emitting diode according to claim 16, wherein the at least one fluoranthene derivative of the formula I is selected from the group consisting of 7,8,9,10-tetraphenylfluoranthene, 8-naphthyl-2-yl-7,10-diphenylfluoranthene, 8-nonyl-9-octyl-7,10-diphenylfluoranthene, benzene-1,4-bis-(2,9-diphenylfluoranth-1-yl), benzene-1,3,5-tris(2,9-diphenylfluoranth-1-yl), 9,9′-dimethyl-7,10,7′, 10′-tetraphenyl-[8,8′]-difluoranthene, 9,10-bis(2,9,10-triphenylfluoranthen-1-yl)anthracene and 9,10-bis(9,10-diphenyl-2-octylfluoranthen-1-yl)anthracene.

23. The organic white light-emitting diode according to claim 16, wherein the blue light-emitting arylamine derivative is selected from the group of triphenylamines of the benzidine type, triphenylamines of the styrylamine type, triphenylamines of the diamine type.

24. The organic white light-emitting diode according to claim 23, wherein the arylamine derivative is 4,4′,4″-tris(N-(1-naphthyl)-N-phenylamino)triphenylamine or 4,4′,4″-tris(N-(2-naphthyl)-N-phenylamino)triphenylamine.

25. A composition comprising at least one blue light-emitting fluoranthene derivative of the formula I as component A as defined in claim 16 and at least one blue light-emitting arylamine derivative as component B, the HOMO energies and LUMO energies of components A and B being different, with the condition that the LUMO energy of component A is higher than the HOMO energy of component B.

26. The composition according to claim 25, wherein the difference in the HOMO energies of components A and B is from 0.5 to 2 eV and the difference in the LUMO energies of components A and B is from 0.5 to 2 eV.

27. A light-emitting layer comprising a composition according to claim 25.

28. An organic white light-emitting diode comprising a composition according to claim 25.

29. A device selected from the group consisting of stationary visual display units such as visual display units of computers, televisions, visual display units in printers, kitchen appliances and advertising panels, illuminations, information panels and mobile visual display units such as visual display units in mobile telephones, laptops, vehicles and destination displays in buses and trains, comprising at least one organic light-emitting diode according to claim 16.

30. An organic white light-emitting diode comprising a light-emitting layer according to claim 27.

31. A device selected from the group consisting of stationary visual display units such as visual display units of computers, televisions, visual display units in printers, kitchen appliances and advertising panels, illuminations, information panels and mobile visual display units such as visual display units in mobile telephones, laptops, vehicles and destination displays in buses and trains, comprising at least one organic light-emitting diode according to claim 16.
